(19) United States
(12) Patent Application Publication
(10) Pub. No.: US 2008/0271338 A1
(43) Pub. Date: Nov. 6, 2008

(54) WET-FLOOR-DRYER CAUTION SIGN

(76) Inventors: Douglas Gordon Muir, Roswell, GA (US); Terry L. Brookshire, Canton, GA (US)

Correspondence Address: MCGUIREWOODS, LLP, 1750 TYSONS BLVD, SUITE 1800, MCLEAN, VA, 22102, US

(21) Appl. No.: 12/015,173

(22) Filed: Jan. 16, 2008

Related U.S. Application Data
(60) Provisional application No. 60/981,006, filed on Oct. 18, 2007.
(60) Provisional application No. 60/924,191, filed on May 3, 2007.

(51) Int. Cl. F26B 25/06; F26B 25/10

(52) U.S. Cl. 34/201; 34/237

(57) ABSTRACT

A device that dries a wet surface, or defrosts a frozen surface, and warns of a slippery condition created by the wet surface, or any hazardous condition in that vicinity. The wet surface may be dried by a fan circulating heated or non-heated air discharged from the center of the hazardous location in an efficient 360 degree pattern via a diffuser. The warning may be visual or audible. The device may be battery powered or powered via a standard extension cord from a common power outlet. The battery may be rechargeable from either standard power outlets or onboard solar cells. The device may be able to disperse deodorizers or insect repellent or insecticides or any combination of these. The device may be able to filter the air. The device is typically quite portable.

### CROSS REFERENCE TO RELATED APPLICATIONS

This application claims benefit of provisional patent application No. 60/981,006, filed on Oct. 18, 2007, entitled “Wet-Floor-Drying Caution Sign”, and provisional patent application No. 60/924,191, filed on May 3, 2007 and entitled Wet-Floor Drying Caution Sign, the disclosures of which are incorporated by reference herein in their entireties.

### BACKGROUND OF THE INVENTION

1.0 Field of the Invention

The invention is directed generally to an apparatus that with a 360 degree air flow pattern via a diffuser both dries a wet surface, and warns users of the possible slippery condition of the wet surface or warns of any hazardous condition in that vicinity and, more particularly, to a caution sign that circulates heated or non-heated air in a 360 degree pattern, that has the ability to disperse deodorizers or insect repellent or insecticides or any combination of these, filter the air, through the use of a self-contained rechargeable power source or common power source via a standard extension cord. Moreover, the invention is directed to a device to warn both visually and audibly through the use of a self-contained rechargeable power source or common power source, such as via a standard extension cord.

2.0 Related Art

Slippery surfaces such as wet floors or stairs can be a hazard to pedestrians or other users. Such slippery surfaces can be the result, for example, of liquid spills, floods or overflow, cleaning, even condensation, and/or conditions associated with a freezing environment. These hazards can cause undesirable results, for example, work stoppage or slowdown while the floor dries, and slips and falls, including financial liability for personal injuries sustained.

The hazardous condition of a slippery surface may be addressed by communicating a warning to pedestrians. Conventionally, this warning involves placing a sign on or near the slippery surface, at least until the surface has dried, which provides a visual warning of the hazard. An example of such a conventional caution sign is a Rubbermaid® wet floor sign, part no. RUB627677. Such a caution sign, though, does not shorten the length of time that the hazard exists. Additionally, such a caution sign, providing only a low-to-the-ground, visual warning of the danger, may not be sufficient to adequately communicate the warning when, for example, the sign is obscured by other pedestrians or some other impediment, when the pedestrian is visually impaired and so on.

Alternatively, or in addition to the above solution, these hazardous conditions can be mitigated by treatment with a dryer or fan in order to shorten the length of time that the hazard exists. Historically, this solution involves placing a fan on or near the slippery surface, and providing power to the fan through a power cord. An example of such a conventional fan is a Mytee® Windstar 2500 Air Mover ½ hp floor fan, part no. 2500YEL. Such a dryer or fan, though, does not provide any warning to pedestrians of the hazard and does not offer the option of heated air and does not discharge its air flow over a wide area (pattern). Additionally, the fan and power cord themselves can be a hazard to pedestrians.

United States Publication No. 2003/0115783 discloses a combined floor drier and caution sign. The device is a portable, free-standing floor sign comprising a frame covered with panels attached to each other. The bottom portion of the frame includes a fan unit that is powered by a rechargeable battery or an electrical cord. When the device is placed over a wet area, the fan directs air out of one side of the device to dry the floor on that side. Therefore, having to locate the device on the side of the hazardous location away from the center of the hazardous location, does not warn the passers by as well as the device proposed in this patent application. Also, there are significant differences between the device described by 2003/0115783 and the device covered by this application including the fact that the 2003/0115783 device is a side discharge unit that only dries the surface on one side of the device as opposed to the device covered by this application drying the floor from each side/direction of the device in a 360 degree pattern which is clearly more efficient being located in the center of the hazardous area for drying the wet floor area while notifying passersby of a hazardous condition. Another improvement by the device covered by this application over the device described by 2003/0115783 is the telescopic pole, or static pole, that extends from the top of the device covered by this application that may contain a sign, light, speaker, flag or combination of these, at approximately eye level of passersby to better warn of a hazardous condition in an area where there are a lot of people and movement and the view downward is obstructed.

United States Publication No. 2007/0022939 discloses a Wet Floor Warning Device, comprising a top portion, and a plurality of sides extending from the top portion that are joined to one another to collectively form an interior void. A fan is positioned within the device for diverting air through the interior void, and at least one collar located within the interior void for engaging the top portion of a like device, wherein substantially the entire interior void is filled by the like device, forming a nested arrangement. The device described by U.S. patent publication 2007/0022939 has a low profile due to the design being stackable and this seriously limits the visibility of the device while in use in a crowded or busy area, where there are a lot of people and movement (especially in restaurants where people are carrying trays of food back to their tables or employees are delivering food on trays to tables). In general, the low profile of the device creates a tripping hazard to passersby, customers or employees. The device covered by this application has a taller design, with the option of pole attachments, to alleviate the tripping hazard issue due to low profile design of device 2007/0022939. If one were to imagine tripping over the device described by 2007/0022939 and needing to be able to achieve traction with your feet to secure yourself and not being able to because of a slippery floor due to wet conditions that were suppose to be alleviated instead of compounded, thus increasing the chances of injury due to a harder fall and then possible legal action that the injured party may take due to the hazards being compounded rather than alleviated.

Another important difference from the device covered by this application and the device described by 2007/0022939 is the fundamental design differences due to the fan placement on device described by 2007/0022939 being located at the top of the device creating several problematic design issues, such as: exposure to possible spills from drinks, possible water damage from a wet environment, or children sticking an object down into the fan area. Also, the operational fan discharge distance from the wet surface on device described by 2007/0022939 is much farther than that of the device covered by this application therefore the design of the device covered by this application should be much more efficient in airflow dynamics and overall operation effectiveness. Another significant design difference is that the device described by 2007/0022939 does not offer an option to provide heated air to defrost and notify of hazardous areas, and the device covered by this application does.

United States Publication No. 2007/0157485 discloses a Wet Floor Warning Device with Floor Dryer, comprising a warning device having an air mover incorporated into its construction to aid in drying a wet floor. The device is similar to the device covered by this application in some ways; however, the device described by 2007/0157485 is lacking a built in diffuser and this is a major design difference due to the efficiency of the diffuser and impact on drying in an even 360 degree pattern. The device described by 2007/0157485 also has casters on each corner of the device that hampers and degrades airflow, creating an area of the floor that is not being dried, and therefore not mitigating the dangerous environment of the wet floor on all four corners of the device. This un-dried pattern extends out from the base of the caster and widens as the distance from the caster increases. So at each corner of device described by 2007/0157485, at a distance of 2′ from the caster you will have a swath of approximately 10 to 12 inches wide that is un-dried. At a distance of 3′ feet from the casters that swath of un-dried floor will be approximately 16 to 18 inches and keeps increasing in width as distance increases. This is a major amount of wet floor that is missed by the air flow output of device described by 2007/0157485, but the casters are necessary because of the extreme weight of the device. The device of 2007/0157485 weighs approximately 29 pounds with the attached warning cone, as opposed to the device covered by this application weighs approximately only 10 pounds, which makes the device covered by this application much more portable for employees in a working environment, i.e., going up or down stairs or levels of the work area. Another design problem of device described in 2007/0157485 using casters is that people in the area may be waiting for service or just hanging out and decide to put the palm of their hand on device of 2007/0157485 and lean on it, or need to catch themselves if they stumble by reaching out to the device to steady themselves. This is very common human behavior that could result in a terrible accident. For example, if the wheel locks had been engaged; the device might spin around causing the person to get off balance and probably fall at least to a knee, but more than likely the employee may forget to engage the wheel locks and when the person goes to lean on, or steady themselves from a trip or stumble, the cone, which appears to be a steady prop given that at a glance it looks like a static cone and the casters are not that noticeable, device of 2007/0157485 will take off like a skate board/rocket causing a much more potentially damaging fall.

Also, one of the main reasons for not installing casters on the device covered by this application, aside from disrupting the airflow pattern, is that they protrude from the corners of the device approximately 3 to 4 inches, creating a tripping hazard on the 4 corners of the device that is suppose to be limiting or mitigating a hazardous situation. Given this risk, and the risk of the cone rolling off quickly and causing someone to fail if someone needed to, or decided to bear down or lean on device No. 2007/0157485, coupled with issue of heavy weight limiting the portability it is asserted that the device covered by this application is a much safer and operationally friendly design. Also, the device covered by this application does not leave wide areas of the floor un-dried; it dries in a perfect 360 degree pattern without any objects, like casters, to disrupt the drying air flow.

Accordingly, there is a need for an apparatus that both mitigates the slippery surface by circulating air (heated or non-heated) in a 360 degree pattern with an efficient diffuser from the center of a hazardous area to dry it more efficiently, and more effectively warns pedestrians in crowded and busy areas of the slippery surface or any type of hazardous condition by having taller operation height, with the option if needed for eye level notifications of hazardous conditions, and also includes the ability to disperse deodorizers or insect repellent or insecticides or any combination of these and also filter the air, through the use of self contained, rechargeable power source, or via standard extension cord from common power outlet.

### SUMMARY OF THE INVENTION

The invention meets the foregoing need and provides a highly portable apparatus with on board power source that both dries a wet surface and warns users of the possible slippery conditions of the wet surface, or warns of any hazardous condition in the area that could be unsafe, such as construction issues, equipment malfunctions, building maintenance, etc., and has the option of dispersing deodorizers, insect repellent and insecticides or any combination of these, and also filtering the air, through the use of self contained, rechargeable power source, or via standard extension cord from a common power outlet and that furthermore includes other advantages apparent from the discussion herein.

In one aspect, a device is provided comprising a warning unit, an air circulating unit to circulate air, and an enclosure having a base and a top with at least one first opening proximate the base and one or more second openings proximate the top the enclosure having at least one inner side to attach the warning unit and to attach the air circulating unit, and to permit the air to circulate through the interior of the enclosure and through at least one first opening in the base, wherein at least one first opening in the base permits air flow in substantially 360 degrees at the base, into or out of the enclosure.

In another aspect, a device is provided comprising means to provide warning of a wet surface and means for drying the wet surface so that an air flow is created at a base of the device in a direction substantially 360 degree outwardly from the base to flow across the wet surface to dry the wet surface by evaporation.

Additional features, advantages, and embodiments of the invention may be set forth or apparent from consideration of the following detailed description, drawings, and claims. Moreover, it is to be understood that both the foregoing summary of the invention and the following detailed description are exemplary and intended to provide further explanation without limiting the scope of the invention as claimed.

### BRIEF DESCRIPTION OF THE DRAWINGS

The accompanying drawings, which are included to provide a further understanding of the invention, are incorporated in and constitute a part of this specification, illustrate embodiments of the invention, and together with the detailed description, serve to explain the principles of the invention. No attempt is made to show structural details of the invention in more detail than may be necessary for a fundamental understanding of the invention and the various ways in which it may be practiced. In the drawings:

FIG. 1A shows a lower internal cross-sectional view of a device constructed according to principles of the invention;

FIG. 1B shows a cut-away cross-sectional side view of the invention of FIG. 1A;

FIG. 1C is an internal view of an embodiment of the invention, showing various additional features and/or alternate placement of features, constructed according to principles of the invention;

FIG. 1D is a cut away side view of an embodiment of the invention similar to FIG. 1B, except showing a pole attachment for an elevated visual or audible warning device, and powered by external power, constructed according to principles of the invention; and

FIG. 2 shows a top view of the invention of FIG. 1B.

### DETAILED DESCRIPTION OF THE INVENTION

The embodiments of the invention and the various features and advantageous details thereof are explained more fully with reference to the non-limiting embodiments and examples that are described and/or illustrated in the accompanying drawings and detailed in the following description. It should be noted that the features illustrated in the drawings are not necessarily drawn to scale and features of one embodiment may be employed with other embodiments as the skilled artisan would recognize, even if not explicitly stated herein. Descriptions of well-known components and processing techniques may be omitted so as to not unnecessarily obscure the embodiments of the invention. The examples used herein are intended merely to facilitate an understanding of ways in which the invention may be practiced and to further enable those of skill in the art to practice the embodiments of the invention. Accordingly, the examples and embodiments herein should not be construed as limiting the scope of the invention, which is defined solely by the appended claims and applicable law. Moreover, it is noted that like reference numerals represent similar parts throughout the several views of the drawings.

It is understood that the invention is not limited to the particular methodology, protocols, devices: apparatus, materials, applications, etc., described herein, as these may vary. It is also to be understood that the terminology used herein is used for the purpose of describing particular embodiments only, and is not intended to limit the scope of the invention. It must be noted that as used herein and in the appended claims, the singular forms “a,” “an,” and “the” include plural reference unless the context clearly dictates otherwise.

Unless defined otherwise, all technical and scientific terms used herein have the same meanings as commonly understood by one of ordinary skill in the art to which this invention belongs. Preferred methods, devices, and materials are described, although any methods and materials similar or equivalent to those described herein can be used in the practice or testing of the invention.

In aspects, the invention comprises both a warning to pedestrians of a possibly hazardous area, or a hazardous slippery wet surface, and circulation of air, heated or non-heated, in a 360 degree pattern via a diffuser in order to more quickly dry the wet surface. The warning may be similar to conventional caution signs, displaying a static message to pedestrians of a slippery surface, for example, “CAUTION WET FLOOR” or a more universally recognized icon such as a slipping and falling stick figure. Optionally, the warning may comprise a dynamic or variable visual message, such as one formed by a light emitting diode (LED) or liquid crystal display (LCD), which could be programmed to display a warning sign in different languages and/or with different visual images. Alternatively, the message may be displayed in flashing lights (perhaps common incandescent or fluorescent lights), in scrolling text, or in any other known method of attracting a users attention. For example, the sign may comprise a flag, light or sign, mounted to the top of the device via a telescopic or static pole attachment, such that the device is more noticeable. With or without any of the above options, the warning may further comprise a sound or audible message, programmable in different languages, or the like.

The circulation of air may be accomplished by means of a fan mounted within the device. The device may have an air intake at an upper portion such as the top and exhaust outlets at the base (or vice versa), such that the air flows through the device and dries (and/or melts frozen surfaces) any adjacent surfaces more quickly than would be the case without the circulation of air.

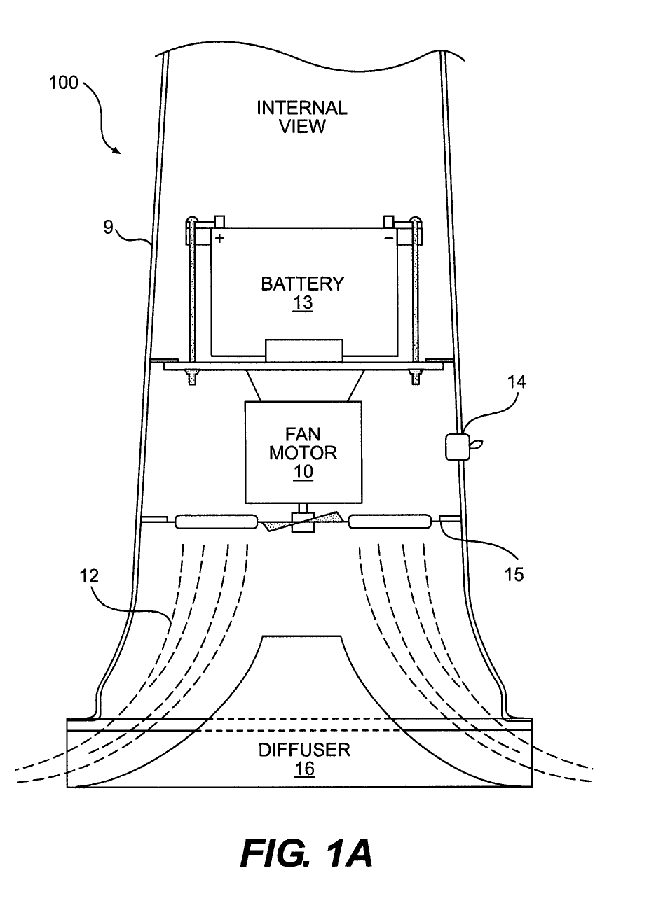

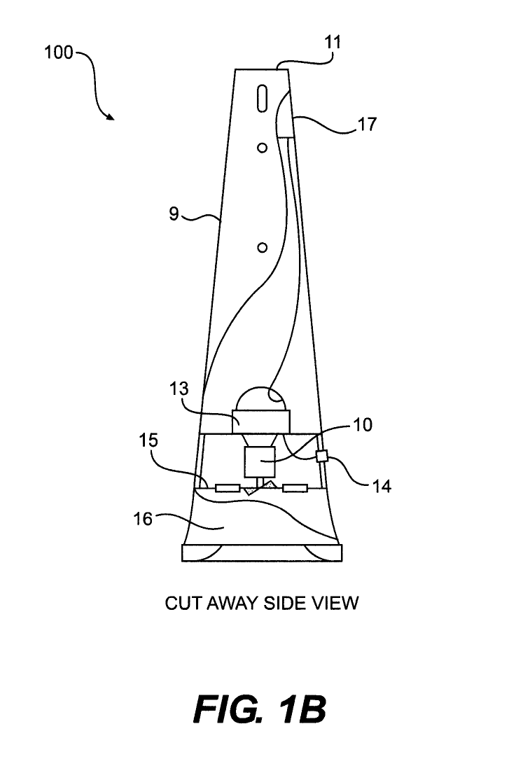

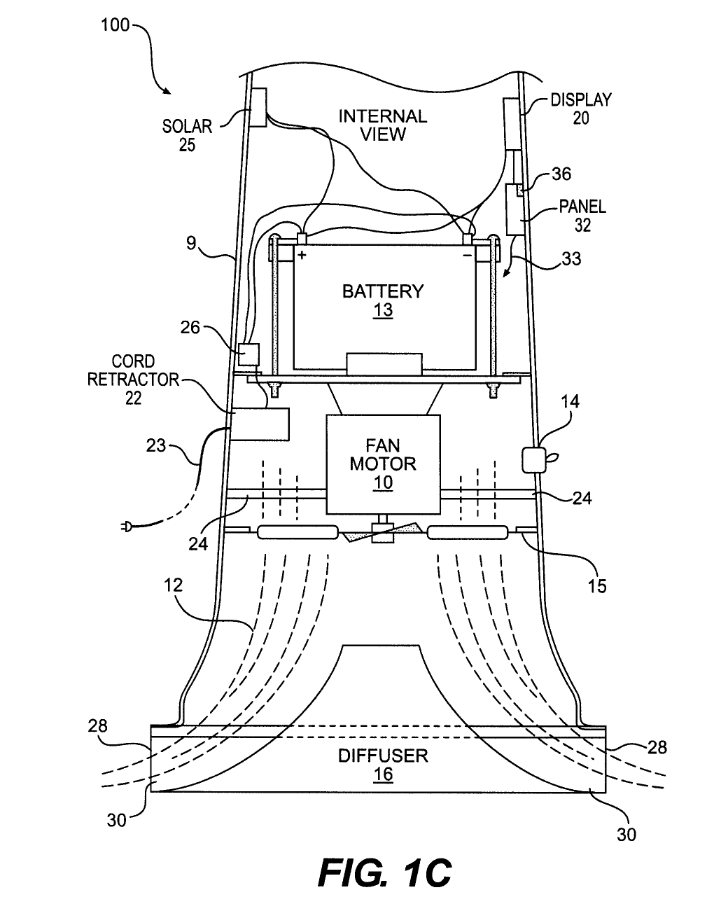

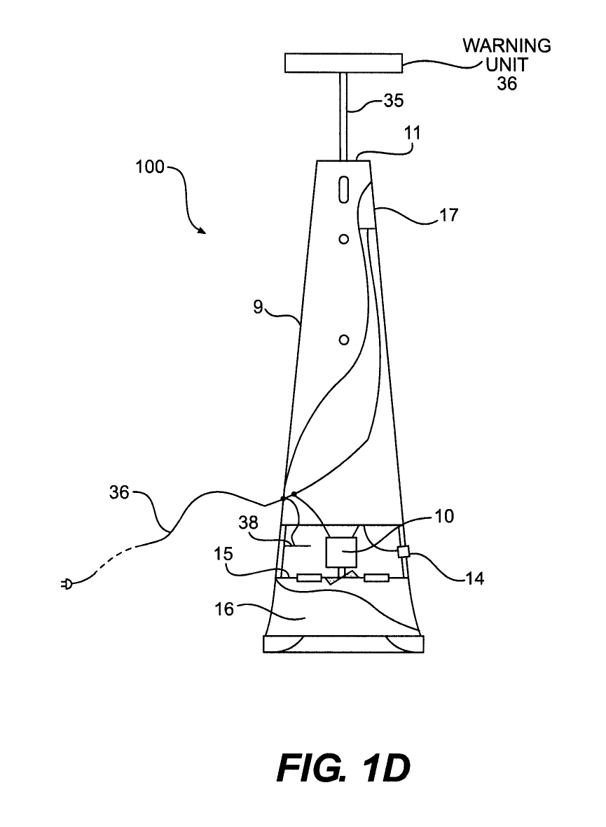

FIG. 1A is an internal view of the invention, generally denoted by reference numeral 100. Referring to FIG. 1A, a device 100 is shown in a lower internal cross sectional view. In a preferred aspect, the device 100 may be constructed of durable plastic or the like, and is typically quite portable. In one aspect, the device 100 may be approximately 36″ in height, approximately 12″ square at its base, and approximately 4.5″ square at its top. In one aspect, the device 100 may be a bright, noticeable color, such as neon yellow, orange, or green. In shape, the device 100 may be in the shape of a pyramid, a triangle, a cone, a rectangle, an obelisk, a tetrahedron, a cylinder, or any other shape effective to achieve the purposes of the invention. Typically, the device 100 has an enclosure 9 substantially forming the basic shape of the device 100 having at least one inner surface for mounting components (e.g., the fan, battery, etc. as described more herein) internally. The enclosure 9 also aids in directing the air flow through the device.

The fan 10 may be mounted somewhat near the base of the device 100, so as to lower the center of gravity and reduce the chance of the device 100 tipping over. Circulating air flows through the device 100 within enclosure 9 and along the path of the dotted lines 12. The air may circulate from an intake vent 11 (see FIG. 1D) proximate the top of the device, down through a hollow center of the device, possibly in an optional configuration past an air treatment section (see FIG. 1C for an example) for providing a deodorizer or insect repellent or insecticide dispersers or any combination of these, or simply a filtering apparatus, to the shrouded fan motor 10 and fan 15, then to the diffuser 16 and exhaust vents 28 proximate the base of the device 100. The exhaust vents 28 may be slats in the base of the device, or may be formed by the gaps between the lower edge of the device, footers, and the surface upon which the device rests. Alternatively, the air may circulate in the opposite direction, from intake vents 30 proximate the base, past the diffuser 16 to the shrouded fan motor 10 and fan 15, possibly in optional configuration past the air treatment section (see an example in reference to FIG. 1C) deodorizer or insect repellent or insecticide dispersers or any combination of these or filtering apparatus (not shown in FIG. 1B), through the hollow center, to exhaust vents proximate the top of the device. In one aspect, the air flows along the path of dotted lines 12, either entering or exiting the device through gaps, typically on all sides of the base of the device, thus achieving maximum air flow. In a further aspect, the gaps might measure approximately 12″ wide by about 1½″ high.

The fan 10 may be powered by a battery 13. The battery 13 may be mounted nearer the bottom of the device 100 than the top of the device 100, so as to lower the center of gravity and reduce the chance of the device 100 tipping over. In one aspect, the battery 13 may be mounted about 11″ from the bottom of the device.

FIG. 1B is a cut-away side view of the invention of FIG. 1A. Referring to FIG. 1B, the battery 13 may be electrically connected to a circuit 17, which may include a rectifier or the like to convert alternating current (AC) to direct current (DC). The circuit 17 may be connected to a standard extension cord, to supply power for operation or recharging. A standard extension cord may be used to recharge the battery 13 via a common (110/120 volt 60 Hz) power supply.

Referring to FIG. 1B the device 100 is shown in cut-away cross-sectional view. The battery 13 may be connected to a control panel or optional actuation switch(es) 14. The control panel (not shown in FIG. 1B, but an example may be found in relation to FIG. 1C) enables an operator to control certain features of the device, for example: turning on and off various functions such as the LED or LCD, the fan, or the sound, setting the volume of the sound, setting the speed of the fan, inputting the caution message to be displayed visually or played audibly, setting a timer for automatic shut-off of the device, etc. Additionally, the blades of the fan 15 may be surrounded by a shroud, and a diffuser 16 such that the air flow through the fan 15, and discharge or intake area is drastically increased.

FIG. 1C is an internal view of an embodiment of the invention, showing various additional features and/or alternate placement of features. Any of the additional features or alternate placement of features of FIG. 1C may be incorporated in any combination, as appropriate (while avoiding unnecessary duplication or incompatible functionality, as an ordinary skilled artisan would recognize) into the embodiment of FIGS. 1A, 1B and 1D. Referring to FIG. 1C, a control panel 32 may be electrically connected 33 to any of the electrical functions (e.g., fan, display, volume setting, audible output, etc.), by appropriate cabling. The control panel 32 may provide convenient user control of certain features of the device such as setting fan speed control, volume control of the audible output 36 (shown in this example as part of the control panel, but could be placed as a separate component with appropriate connectivity elsewhere in the device 100), selection of messages for display 20 (perhaps with time of day settings to change messages or turn off messages based on a schedule or a predetermined time period). The audible output 36: such as a speaker, may also be used to give a notice of a low battery. The display 20 may be of any size or these may be multiple displays and might include LED or LCD technologies, for example.

A charging circuit 26 (perhaps as an alternative to circuit 17) typically with suitable safety circuitry for protecting users and device electrical components is typically connected to the battery 13 for charging purposes. Typically, the battery 13 also supplies power for the electrical features of the device 100 such as the panel 36, display 20, fan 15, and audible output 36, as appropriate. A retractable power cord 23 may be retracted by the cord retractor 22. An optional solar charging unit 25 may also be used in addition to, or in lieu of, the charger 26. In a preferred embodiment, only one charger unit is used, which may be operatively connected to a solar source and/or an AC power source.

The embodiment of FIG. 1C may also include an air treatment section 24 which may treat air may circulated from an intake vent (such as the vent 11 of FIG. 1D, for example) on or near the top of the device, down through a hollow center of the device to exit vents 28, for providing a deodorizer or insect repellent or insecticide dispersers or any combination of these, or simply a filtering apparatus. Alternatively, the air may circulate in the opposite direction, from intake vents 30 in the base, past the diffuser 16 to the shrouded fan motor 10 and fan 15, possibly in optional configuration past the air treatment section 24. Exit vents 28 and intake vents 30 are typically the same openings, but may be different. The placement of the air treatment section 24 could also be placed at a different part of the device, perhaps nearer the exit vents 30 or even above the fan 15; the placement of the air treatment section 24 of FIG. 1C is just an example.

FIG. 1D is a cut away side view of an embodiment of the invention similar to FIG. 1B, except showing a pole attachment for an elevated visual or audible warning device, and powered by external power, constructed according to principles of the invention. The eye level pole attachment 35 extends from the enclosure of the device 100, usually from the top, to support a warning unit 36, which may be an audible warning device or a visual warning device (or both). The eye level attachment (or at least at an elevated height from the top of the device) and warning unit 36 may be used in conjunction with any embodiment herein. The warning unit 36 of FIG. 1D may be in addition to, or in lieu of, any display or warning unit in any other embodiment. FIG. 1D also shows that the fan 15 and circuit 17 may be powered by a standard extension type cord 36, in lieu of an internal battery. The power cord 36 may be used in conjunction with any other embodiment, with or without a battery, as appropriate. Also included may be a heater element 38 to heat the air flow through the enclosure of the device 100. The heater unit may be included as part of the air moving apparatus (i.e., the fan and motor). The heater element 38 feature may be used with any embodiment herein.

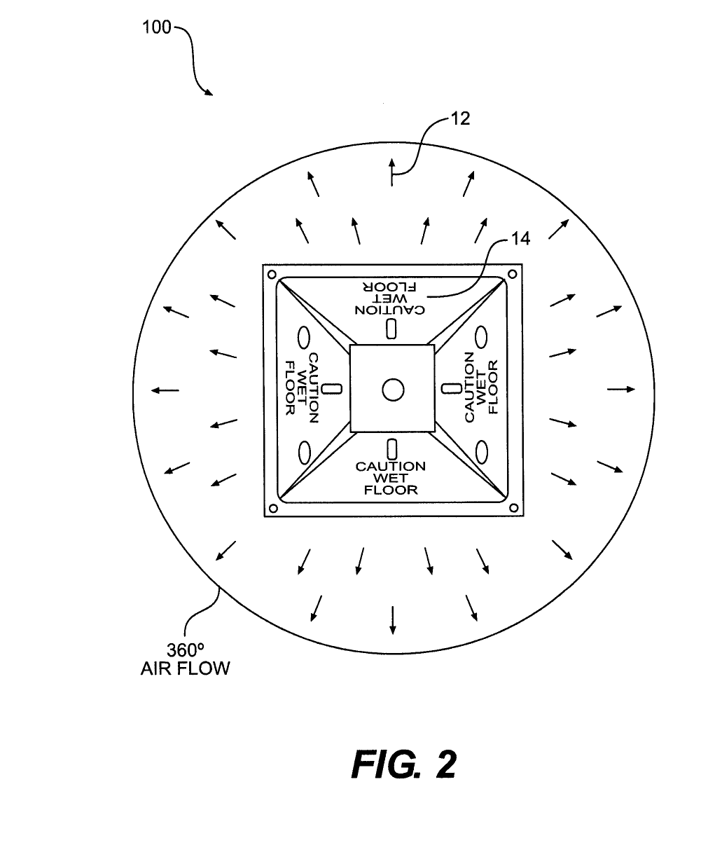

Referring to FIG. 2, a top view of an embodiment of the device 100 is shown. This perspective shows an efficient 360 degree air flow pattern provided by the invention. The bottom view of the fan showing the shroud and the diffuser from the bottom is not included, but it will be understood by those of skill in the art that the opening in the center of the shroud, and the form of the diffuser, may be square, rectangular, circular, oval or any other shape effective to achieve the purposes of the invention. The outwardly flow of air from a base of the device is substantially in a 360 degree direction around the base to permit drying of a wet surface by evaporation.

Referring again to FIG. 1C, the display 20 could be positioned near the top of the device. As discussed above, the display 20 could be applied to the embodiment of FIGS. 1A and 1B. The visual image produced by display 20 may be, for example, a static display of a word, such as “CAUTION,” or a graphic, such as an icon of a slipping and falling stick figure. The visual display may be a dynamic display, for example, a programmable LED displaying a word, such as “CAUTION,” or that word's translation in another language (or even displayed in a plurality of languages). Additionally, the visual display may include, for example, any one or combination of the following: scrolling text, flashing lights, colored lights and so on. Language selection for display modes may also be accomplished through the control panel 32.

In an alternative aspect, the invention may further include a circuit (perhaps as part of the control panel 32) that may provide an audio warning message in addition to or as an alternative to the displayed (visual) message. For example, the device 100 may include speakers (perhaps audible output 36) to communicate a beep or chime, or to play a recorded message stating “Caution” or the like.

While the invention has been described in terms of exemplary embodiments those skilled in the art will recognize that the invention can be practiced with modifications in the spirit and scope of the appended claims. These examples given above are merely illustrative and are not meant to be an exhaustive list of all possible designs, embodiments, applications or modifications of the invention.

What is claimed:

1. A device comprising:
a warning unit;
an air circulating unit to circulate air; and
an enclosure having a base and a top with at least one first opening proximate the base and one or more second openings proximate the top, the enclosure having at least one inner side to attach the warning unit and to attach the air circulating unit and to permit the air to circulate through the interior of the enclosure and through the at least one first opening in the base,
wherein at least one first opening in the base permits air flow in substantially 360 degrees at the base, into or out of the enclosure.

2. The device according to claim 1, wherein the warning unit is a visual display unit.

3. The device according to claim 2, wherein the visual display unit includes one of a light emitting diode (LED) or a liquid crystal display (LCD).

4. The device according to claim 1, wherein the warning unit comprises an audio output unit.

5. A device according to claim 1, wherein the device has eye level pole attachment of visual or audible warning device.

6. The device according to claim 1, wherein the air circulating unit is a fan.

7. The device according to claim 6, wherein the fan is surrounded by a shroud that lies substantially perpendicular to the direction of airflow through the fan.

8. The device according to claim 1, further comprises an air treatment section and wherein the air flows past the air treatment section and disperses a deodorizer, insect repellent, insecticide, or any combination thereof.

9. The device according to claim 1, further comprising an air treatment section to filter the air.

10. The device according to claim 1, further comprising a battery, wherein the warning unit and the air circulating unit are powered by the battery.

11. The device according to claim 10, wherein the battery is rechargeable.

12. The device according to claim 10, wherein the battery recharges from a solar unit.

13. The device according to claim 1, further comprising a diffuser in the enclosure to diffuse the air flow proximate the base.

14. The device according to claim 1, wherein power is supplied by an extension cord.

15. The device according to claim 1, further comprising a heating unit to heat the air flow.

16. A device comprising:
means to provide warning of a wet surface; and
means for drying the wet surface so that an air flow is created at a base of the device in a direction substantially 360 degrees outwardly from the base to flow across the wet surface to dry the wet surface by evaporation.

17. The device according to claim 16, wherein the warning means is visual.

18. The device according to claim 16, wherein the warning means is audible.

19. The device according to claim 16, further comprising an extension attachment to display a visual or audible warning device at a substantially elevated height.

20. The device according to claim 16, further comprising a heating unit to heat the air flow.

21. A device according to claim 16, wherein the drying means circulates air through an enclosure containing the drying means.

22. A device according to claim 16, further comprising a battery to power the warning means and the drying means.

23. A device according to claim 22, wherein the battery is rechargeable.

24. A device according to claim 22, wherein the battery recharges from a solar unit.

25. The device according to claim 16 wherein the air flow is configured to disperse a deodorizer, insect repellent, insecticide, or any combination thereof.

26. The device according to claim 16, further comprising an air filter unit to filter the air flow.

27. The device of claim 16, further comprising a power cord retractor to retract a power cord.

28. The device of claim 16, further comprising a control panel to control operation of the means for drying and the means for warning.
